(19) United States
(12) Patent Application Publication
(10) Pub. No.: US 2025/0223425 A1
(43) Pub. Date: Jul. 10, 2025

(54) COMPOSTABLE COMPATIBILIZERS FOR BLENDS OF BIODEGRADABLE ELASTOMERS AND BIODEGRADABLE THERMOPLASTIC POLYESTERS AND METHOD OF PRODUCTION THEREOF

(71) Applicant: Erthos Inc., Mississauga (CA)

(72) Inventors: Emmanuel Olusegun OGUNSONA, Mississauga (CA); Nima ZARRINBAKHSH, Mississauga (CA); Hossein ABDOLI, Mississauga (CA); Shadi MESHKAT ALSADAT, Mississauga (CA); Devni Nayanathara ELAMALDENIYA, Mississauga (CA); Kritika TYAGI, Mississauga (CA); Felix SARACI, Mississauga (CA)

(21) Appl. No.: 18/404,476

(22) Filed: Jan. 4, 2024

(51) Int. Cl. C08K 5/09; B29B 7/00; B29C 45/00; B29K 67/00; C08L 67/04

(52) U.S. Cl. CPC C08K 5/09; B29B 7/005; B29C 45/0001; C08L 67/04; B29C 2945/76531; B29K 2067/046; B29K 2995/006; C08L 2201/06; C08L 2203/30; C08L 2205/025; C08L 2205/06; C08L 2205/08; C08L 2207/04

(57) ABSTRACT

The invention encompasses compositions of biodegradable polyester elastomers and biodegradable thermoplastic polyesters with enhanced compatibility using compostable compatibilizing agents. The compositions can be used for melt processing purposes such as extrusion, batch mixing, injection molding, and compression molding. In various embodiments, the compositions encompass polymer blends comprised of at least one biodegradable polyester elastomer, one biodegradable thermoplastic polyester, and one compostable compatibilizing agent. The invention allows for tailored compatibility of the composition through direct compounding of the biodegradable polyester elastomer, the biodegradable thermoplastic polyester, and the compostable compatibilizing agent.

### FIELD OF INVENTION

The invention encompasses compositions and methods for enhancing the compatibility between biodegradable polyester elastomers and biodegradable thermoplastic polyesters for melt blending purposes, and the compositions and methods for preparing such blends. The invention further encompasses compositions and methods of employing compostable compatibilizers that can be used directly as an additive to improve the compatibility of the biodegradable polyester elastomers and biodegradable thermoplastic polyesters during a melt process including, but not limited to, twin or single screw extrusion, batch mixing, injection molding, film extrusion, and compression molding. The resulting blends exhibit improvements in mechanical properties including, but not limited to, tensile and flexural strengths, Young's modulus, elongation at break, and melt flow rate. This invention is helpful for a variety of polymer processing applications where the use of non-biodegradable and non-biobased compatibilizers is restricted. Additional benefits of such methods are described in the invention.

### BACKGROUND OF THE INVENTION

Biodegradable elastomers and biodegradable thermoplastic polymers have gained increased attention due to the potential of eliminating environmental issues associated with traditional petroleum-based polymers. Likewise, these both possess attractive properties for a wide range of applications.

Within the spectrum of biodegradable elastomers, those produced from the polycondensation of polyols and diacids stand out. This family of elastomers has carved a niche under the umbrella of green and sustainable materials stemming from the biodegradable property. For example, PGS, resulting from the polycondensation of glycerol and sebacic acid, is recognized for its biocompatibility and adaptability in biomedical applications, especially in tissue engineering. Its properties and degradation rates can be finely tuned according to the specifics of its intended application. In another example, PGSu is derived similarly but from succinic acid as the diacid. It holds promise not only in biomedicine but also as an eco-friendly alternative in other sectors.

Blending polymers derived from renewable sources often results in phase separation and poor interfacial adhesion due to inherent differences in their chemical structures and physical properties. This phase separation can lead to compromised mechanical and thermal properties and processability. Thus, there is a need for compatibilizers that can improve the miscibility and interfacial adhesion between these polymers. However, there is not extensive research on improving the compatibility of biodegradable elastomers and biodegradable thermoplastics polyesters.

### SUMMARY OF THE INVENTION

The invention encompasses compostable compatibilizing agents that enhance the compatibility between biodegradable polyester elastomers and biodegradable thermoplastic polyesters when directly employed in the melt-blending process of these materials. The compatibilized mixtures demonstrate enhanced processability and mechanical properties compared to similar blends that do not contain any compatibilizing agent.

In certain embodiments, the procedures for the synthesis of the compostable compatibilizing agents and biodegradable polyester elastomers, as well as the melt blending process of biodegradable polyester elastomers, compostable compatibilizing agents, and biodegradable thermoplastic polyesters in specific weight ratios are provided. The formulated blend compositions are capable of being remelted and reshaped using various techniques, such as injection molding, compression molding, and cast film extrusion, enabling the formation of a range of rigid and flexible polymeric materials for different applications.

In certain embodiments, the development of compostable compatibilizers extends the range of molecular weights of biodegradable thermoplastic polyesters. In other embodiments, the synthesis of biodegradable polyester elastomers extends various degrees of crosslinking, or gel content that can also be used. The blend development process extends the range of molecular weights of different polymers that can be used and melt-blended at various weight ratios with different ratios of compatibilizers and elastomers.

In one embodiment, the invention encompasses a composition comprising a compostable compatibilizing agent that is the product of a hydrolyzation reaction of at least one biodegradable thermoplastic polyester including, but not limited to, polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs) or a combination thereof.

In one embodiment, the hydrolyzation reaction occurs in the presence of 0.01 to 30 weight percent of one or more organic acids including but not limited to lactic acid, formic acid, stearic acid, tannic acid, malic acid, citric acid, aspartic acid, ascorbic acid, acetic acid, tartaric acid. In various embodiments, the amount of the one or more organic acids is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

In one embodiment, the hydrolyzed compatibilizer is produced by melt-compounding one biodegradable thermoplastic polyester with one organic acid.

In one embodiment, the hydrolyzed compatibilizer is produced by melt-compounding one or more biodegradable thermoplastic polyesters with one organic acid.

In one embodiment, the hydrolyzed compatibilizer is produced by melt-compounding one or more biodegradable thermoplastic polyesters with one or more organic acids.

In one embodiment, the hydrolyzed compatibilizer is produced by melt-compounding one biodegradable thermoplastic polyester with one or more organic acids.

In one embodiment, the hydrolyzed compatibilizer is produced by first melting one or more biodegradable thermoplastic polyesters and then compounding with one or more organic acids.

In one embodiment, the hydrolyzed compatibilizer is produced by melt-compounding one or more biodegradable thermoplastic polyesters with one or more organic acids and then further melt-compounding with one or more biodegradable thermoplastic polyesters and organic acids.

In one embodiment, the hydrolyzed compatibilizer is produced by melt-compounding one or more biodegradable thermoplastic polyesters with one or more organic acids and then further compounding with one or more biodegradable thermoplastic polyesters.

The aforementioned ingredients and method of production of the hydrolyzed compatibilizer may be achieved using mixing and melt-compounding equipment with adjustable and controllable temperatures and shear rates, such as an extruder or a batch mixer. In a batch mixer, the processing temperature profile may range from 50 to 250° C., the mixing blades' speed may be between 20 and 500 rpm and the processing time may be between a few seconds to several minutes. Alternatively, in embodiments where a single or twin screw extruder is employed, the temperature profile may range from 50 to 250° C., the screw speed may range from 20 to 500 rpm, and the processing time may be between a few seconds to several minutes. It should be noted that the processing conditions and methods of production provided herein are not limiting and may vary based on other conditions such as ingredient amounts and ratios and the type of processing equipment.

In one embodiment, the hydrolyzed compatibilizing agent is a result of a hydrolyzation reaction of one or more biodegradable thermoplastic polyester with one or more organic acids at a temperature higher than ambient temperature and for a prescribed time.

In one embodiment, the hydrolyzed compatibilizing agent is a result of the hydrolyzation of polylactic acid with one or more organic acids at a temperature higher than ambient temperature and for a prescribed time.

In one embodiment, the hydrolyzed compatibilizing agent is a result of the hydrolyzation of polybutylene succinate with one or more organic acids at a temperature higher than ambient temperature and for a prescribed time.

In one embodiment, the hydrolyzed compatibilizing agent is a result of the hydrolyzation of polybutylene adipate-co-terephthalate with one or more organic acids at a temperature higher than ambient temperature and for a prescribed time.

In one embodiment, the hydrolyzed compatibilizing agent is a result of the hydrolyzation of polyhydroxyalkanoates with one or more organic acids at a temperature higher than ambient temperature and for a prescribed time.

In certain embodiments, the hydrolyzed compatibilizing agent is a result of a hydrolyzation of polylactic acid and polybutylene succinate with one or more organic acids at a temperature higher than ambient temperature and for a prescribed time.

In one embodiment, the hydrolyzed compatibilizing agent is a result of a hydrolyzation of polylactic acid, polybutylene succinate, and polybutylene adipate-co-terephthalate with one or more organic acids at a temperature higher than ambient temperature and for a prescribed time.

In one embodiment the compostable compatibilizing agent includes at least one organic acid such as lactic acid, formic acid, stearic acid, tannic acid, malic acid, citric acid, aspartic acid, ascorbic acid, acetic acid, tartaric acid, or a combination thereof.

In one embodiment the compostable compatibilizing agent includes at least one organic acid such as lactic acid, formic acid, stearic acid, tannic acid, malic acid, citric acid, aspartic acid, ascorbic acid, acetic acid, tartaric acid, or a combination thereof and at least one or two hydrolyzed compatibilizing agents.

In one embodiment, the biodegradable polyester elastomer synthesis includes a polyol encompassing but not limited to sorbitol, mannitol, galactitol, xylitol, ribitol, arabitol, erythritol, glycerol, threitol, and derivatives thereof, and an organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or derivatives thereof. The molar ratio of polyol to dicarboxylic acid is in the range of 0.32, 0.7, 0.8, 0.9, and 1.28.

In one embodiment, the method for the production of the biodegradable polyester elastomer can be any of the following but not limited to the use of at least a polyol, an organic acid, and optionally other additives including but not limited to plasticizer, initiator, filler, compatibilizer, etc.

In one embodiment a polyol to organic acid molar ratio, ranging from about 0.2 to about 1.5, preferably 0.25 to about 1.35 and more preferably from about 0.32 to about 1.28 was employed. In one embodiment, the reactants are premixed in a reaction vessel and then raised to a desired temperature. In another embodiment, the organic acid is melted before the addition of polyol and other optional additives under stirring in a reaction vessel. In another embodiment, the polyol and other optional additives are premixed prior to the addition of an organic acid. In another embodiment, the organic acid and polyol are mixed and heated to a specific temperature before the addition of any other optional additives.

In one embodiment, the reaction vessel could be made of heat and crack-resistant glassware, stainless steel or high-temperature-resistant plastic, equipped with an overhead stirrer. The temperature of the mixtures is increased to the desired reaction temperature and maintained throughout the reaction. The reaction is cooled down slowly or rapidly and considered complete after a period ranging from a few minutes to a few hours.

In certain embodiments, the reaction is set at temperatures ranging from 100 to 250° C. Reagents are agitated from the point of mixture and at room temperature. In another embodiment, the agitation is started after the reagents are melted. The reaction is continued until the desired consistency of the elastomer is achieved. In one embodiment, agitation is continued after achieving the desired consistency of elastomer for a period ranging from 1 minute to a few hours. In another embodiment, the agitation is increased or decreased after achieving the desired consistency of elastomer. In another embodiment, agitation is stopped after achieving the desired consistency of elastomer.

In one embodiment, the final composition of the biodegradable resin includes a blend of at least one or more biodegradable thermoplastic polyesters such as polylactic acid, polycaprolactone, polybutylene succinate, polybutylene succinate adipate, polybutylene succinate terephthalate, polybutylene adipate-co-terephthalate, and polyhydroxyalkanoates, with a weight ratio ranging from 10 to 99.99, at least one or more biodegradable polyester elastomers with a weight ratio of 1 to 90 and one or more compatibilizing agents with a weight ratio of 0.01 to 30.

In various embodiments, the amount of the one or more biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%.

In various embodiments, the amount of the one or more biodegradable polyester elastomers is about 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, or about 90%.

In various embodiments, the amount of the one or more compatibilizing agents is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

In one embodiment, the final composition of the biodegradable resin includes a blend of at least one or more biodegradable thermoplastic polyesters, one or more polyester elastomers, and one or more hydrolyzed compatibilizers of this invention as the compatibilizing agent.

In one embodiment, the final composition of the biodegradable resin includes a blend of at least one or more biodegradable thermoplastic polyesters, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin includes a blend of at least one or more biodegradable thermoplastic polyesters, one or more polyester elastomers, one or more hydrolyzed compatibilizers of this invention as a compatibilizing agent, and at least one organic acid such as lactic acid, formic acid, stearic acid, tannic acid, malic acid, citric acid, aspartic acid, ascorbic acid, acetic acid, tartaric acid, or a combination thereof as another compatibilizing agent of this invention.

In one embodiment, the final composition of the biodegradable resin is a blend of polylactic acid, one or more polyester elastomers, and hydrolyzed polylactic acid of this invention as the compatibilizing agent.

In one embodiment, the final composition of the biodegradable resin is a mixture of polylactic acid, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polylactic acid, one or more polyester elastomers, hydrolyzed polylactic acid of this invention as a compatibilizing agent and at least one organic acid such as lactic acid, formic acid, stearic acid, tannic acid, malic acid, citric acid, aspartic acid, ascorbic acid, acetic acid, tartaric acid, or a combination thereof as another compatibilizing agent of this invention.

In one embodiment, the final composition of the biodegradable resin is a mixture of polycaprolactone, one or more polyester elastomers, and hydrolyzed polycaprolactone of this invention as the compatibilizing agent.

In one embodiment, the final composition of the biodegradable resin is a mixture of polycaprolactone, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polycaprolactone, one or more polyester elastomers, hydrolyzed polycaprolactone of this invention as a compatibilizing agent and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In one embodiment, the final composition of the biodegradable resin is a mixture of polybutylene succinate, one or more polyester elastomers, and hydrolyzed polybutylene succinate of this invention as the compatibilizing agent.

In one embodiment, the final composition of the biodegradable resin is a mixture of polybutylene succinate, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polybutylene succinate, one or more polyester elastomers, hydrolyzed polybutylene succinate of this invention as a compatibilizing agent and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In one embodiment, the final composition of the biodegradable resin is a mixture of polybutylene succinate adipate, one or more polyester elastomers, and hydrolyzed polybutylene succinate adipate of this invention as the compatibilizing agent.

In one embodiment, the final composition of the biodegradable resin is a mixture of polybutylene succinate adipate, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polybutylene succinate adipate, one or more polyester elastomers, hydrolyzed polybutylene succinate adipate of this invention as a compatibilizing agent, and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In one embodiment, the final composition of the biodegradable resin is a mixture of polybutylene succinate terephthalate, one or more polyester elastomers, and hydrolyzed polybutylene succinate terephthalate of this invention as the compatibilizing agent.

In one embodiment, the final composition of the biodegradable resin is a mixture of polybutylene succinate terephthalate, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polybutylene succinate terephthalate, one or more polyester elastomers, hydrolyzed polybutylene succinate terephthalate of this invention as a compatibilizing agent and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In one embodiment, the final composition of the biodegradable resin is a mixture of polybutylene adipate-co-terephthalate, one or more polyester elastomers, and hydrolyzed polybutylene adipate-co-terephthalate of this invention as the compatibilizing agent.

In one embodiment, the final composition of the biodegradable resin is a mixture of polybutylene adipate-co-terephthalate, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polybutylene adipate-co-terephthalate, one or more polyester elastomers, hydrolyzed polybutylene adipate-co-terephthalate of this invention as a compatibilizing agent and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In one embodiment, the final composition of the biodegradable resin is a mixture of polyhydroxyalkanoates, one or more polyester elastomers, and hydrolyzed polyhydroxyalkanoates of this invention as the compatibilizing agent.

In one embodiment, the final composition of the biodegradable resin is a mixture of polyhydroxyalkanoates, one or more polyester elastomers, and at least one organic acid such as lactic acid, formic acid, stearic acid, tannic acid, malic acid, citric acid, aspartic acid, ascorbic acid, acetic acid, tartaric acid, or a combination thereof as the compatibilizing agent of this invention.

In one embodiment, the final composition of the biodegradable resin is a mixture of polyhydroxyalkanoates, one or more polyester elastomers, hydrolyzed polyhydroxyalkanoates of this invention as a compatibilizing agent and at least one organic acid such as lactic acid, formic acid, stearic acid, tannic acid, malic acid, citric acid, aspartic acid, ascorbic acid, acetic acid, tartaric acid or a combination thereof as another compatibilizing agent of this invention.

In certain embodiments, the plasticization of a resin comprising biodegradable thermoplastic polyester(s) and biodegradable polyester elastomer(s) is achieved at different weight percentages including, but not limited to, 0 to about 30 of a biodegradable plasticizer. In various embodiments, the amount of the biodegradable plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

Biodegradable plasticizers are employed, which encompass, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin form or post-modification (e.g., modification through epoxidation, carboxylation, hydroxylation, and amidation). Modified plant-based oils such as epoxidized soybean oil, epoxidized linseed oil, fatty acid methyl esters, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In certain embodiments, the biodegradable resin further includes fillers in weight percentages within a range of 0 to about 30, which encompasses both inorganic and biomass fillers and a combination thereof. In various embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5% or about 30%.

In certain embodiments, the inorganic fillers include but are not limited to, wollastonite, mica, clay, calcium carbonate, glass fiber, talc, aluminum silicate, zirconium oxide, sepiolite, gypsum and other minerals and a combination thereof.

In certain embodiments, the biomass includes but is not limited to, distillers' grains, vinasse, vinegar residues, wood fiber, virgin starch, modified starch including thermoplastic starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the final composition of the biodegradable resin exhibits an improvement in elongation at break of about 50%, 60%, 70%, 75%, 77%, or 80% after the compatibilization between the elastomer and the biodegradable thermoplastic polyester is achieved using a compatibilizing agent of this invention.

In certain embodiments, the final composition of the biodegradable resin exhibits an increase in rigidity (represented by Young's modulus) by about 8%, 10%, 12%, 14%, 16%, 18%, or about 20% after the compatibilization between the elastomer and the biodegradable thermoplastic polyester is achieved using a compatibilizing agent of this invention.

In certain embodiments, the final composition of the biodegradable resin exhibits an increase in strength (represented by tensile stress at break) by about 10%, 15%, 18%, or about 20% after the compatibilization between the elastomer and the biodegradable thermoplastic polyester, using a compatibilizing agent of this invention.

In certain embodiments, the MFI (melt flow index or melt flow rate) reduces by more than 8% after the compatibility between the elastomer and the biodegradable thermoplastic polyester is improved using a compatibilizing agent of this invention.

In certain embodiments, the processing of the final composition of the biodegradable resin to form a finished polymeric product was not possible without improving the compatibility of the blend.

In certain embodiments, the processing of the final composition of the biodegradable resin to form a finished polymeric product was realized with a compatibilizing agent of this invention included in the final composition of the biodegradable resin.

In certain embodiments, the composition exhibits a bio-based carbon content of up to 100%.

In certain embodiments, the composition exhibits a bio-based carbon content of about 10%, 20%, 30%, 40%, 50%, 60%, 70%, 80%, 90%, 95%, or about 100%.

In certain embodiments, the composition exhibits 10%, 20%, 30%, 40%, 50%. 60%, 70%, 80%, or 90% disintegration completion within about 180 to about 365 days at ambient temperature.

In certain embodiments, the composition exhibits 10%, 20%, 30%, 40%, 50%. 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits more than 90% biodegradation in less than 30, 40, 50, 60, 70, 80, 90, 100, 110, 120, 130, 140, 150, 160, 170, 175, or 180 days.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days under thermophilic temperature conditions.

In certain embodiments, the composition exhibits more than 90% biodegradation in less than 30, 40, 50, 60, 70, 80, 90, 100, 110, 120, 130, 140, 150, 160, 170, 175, or 180 days under thermophilic temperature conditions.

In certain embodiments, the final composition of the biodegradable resin exhibits 32% disintegration within 45 days under mesophilic (home composting) conditions and 46% disintegration within 45 days under thermophilic (industrial composting) conditions.

In certain embodiments, the final composition of the biodegradable resin is 100% compostable.

The sequence of mixing the ingredients can vary and includes but is not limited to the following options.

In certain embodiments, all ingredients are introduced to a batch mixer or extruder for a prescribed period at temperatures higher than ambient temperature.

In certain embodiments, the thermoplastic polyester(s) are melted using a batch mixer or an extruder for a prescribed period at temperatures higher than ambient temperature and then the biodegradable elastomer(s) is introduced to the system before the addition of the compostable compatibilizer(s).

In certain embodiments, the thermoplastic polyester(s) are melted using a batch mixer or an extruder for a prescribed period at temperatures higher than ambient temperature and then the compostable compatibilizer(s) is introduced to the system before the addition of the biodegradable elastomer(s).

In certain embodiments, the biodegradable elastomer(s) and compostable compatibilizer(s) are first charged into a batch mixer or an extruder for a prescribed period at temperatures higher than ambient temperature, and then the thermoplastic polyester(s) are introduced to the system.

In certain embodiments, other additives may be introduced into the compounding melt of thermoplastic polyester(s), biodegradable elastomer(s) and compostable compatibilizer(s) at any point during the process.

In various embodiments, the additives can include but are not limited to biodegradable plasticizers, biomasses, inorganic or organic fillers, coupling agents, compatibilizers, processing aids, chain extenders, pigments, initiators, and peroxides.

In certain embodiments, the method includes further remelting and forming flexible or rigid polymeric parts via conventional polymer processing techniques including, but not limited to, compression molding, hot press, blow molding, cast film extrusion, injection molding, and thermoforming.

In certain embodiments, forming polymeric parts using the resin formulation includes extrusion, where the extrudate is formed at a temperature above ambient temperature, preferably in a range of 120 to 250° C.

In certain embodiments, the biodegradable compositions of the invention can be used in various embodiments from packaging and single-use products to durable products and in a wide range of applications, from packaging to medical, and consumer products, and many more.

### BRIEF DESCRIPTION OF THE DRAWINGS

FIG. 1 is an exemplary cast film extrudate of blend composition without compatibilizing agent of Example 5.

FIG. 2 is an exemplary embodiment of a cast film extrudate of the compatibilized blend composition of Example 5.

### DETAILED DESCRIPTION OF THE INVENTION

### Definitions

The term “biodegradable polyester elastomer” is herein defined to refer to an elastomer synthesized from polyol(s) and a dicarboxylic organic acid(s) that could further include other additives.

The term “hydrolyzation” pertains to the simultaneous reduction and functionalization of biodegradable thermoplastic polyester chains, resulting in the formation of either oligomers or polymers of a lower molecular weight with functional groups like, but not limited to hydroxyls, carboxyls, carbonyls, anhydrides, epoxides, and esters.

The term “compatibilizing agent” or “compatibilizer” refers to hydrolyzed biodegradable thermoplastic polyesters or organic acids employed to enhance the compatibility of the biodegradable polyester elastomers and thermoplastic polyesters in a blend.

The term “bio-based” or “biobased” refers to compositions that are derived fully or partially from plant-based materials instead of being derived fully from petroleum.

The term “thermoplastic,” as used herein, refers to a material, such as a polymer, which softens and becomes moldable and pliable when heated, then hardens when cooled.

The prefix “bio” as used herein refers to a material that has been derived from a renewable resource.

The terms “blend” and “resin” as used herein interchangeably, refer to a homogeneous mixture of two or more different polymers and/or elastomers along with other additives.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The compositions of the invention biodegrade within 12 months.

Compostable plastic is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstock for plastic production include, but are not limited to, corn starch, corn stalks, sugarcane stems, cellulose, and various oils and fats from renewable sources.

As used herein, “compostable” compositions refer to biodegradation into soil conditioning material (i.e., compost). For a plastic to be labeled as industrial “compostable”, be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standard D6400 outlines the specifications that must be met to label a plastic as industrial “compostable”.

The term “disintegration” refers to a plastic product that leaves no more than 10% of its original dry weight after twelve weeks (84 days) in a controlled thermophilic composting test and sieved through a 2.0-mm mesh.

The term “polyesters” refers to polymers of the invention that are obtained, for example, by aliphatic diols, aliphatic dicarboxylic acids, and aromatic dicarboxylic acids/esters. The term polyesters also includes aliphatic and aliphatic-aromatic polyesters. The biodegradable thermoplastic polyesters of the current invention include but are not limited to: polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

As used herein, the term “additive” could refer to any material used to enhance a targeted property or function of material and/or composition, which could be in any form such as solid, liquid, powder, fiber, or crystal.

The term “polyhydroxyalkanoates (PHAs)” refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

As used herein, “wt. %,” “parts by mass (w/w)” or “parts by mass % (w/w)” refer to the percentage weight of an ingredient with respect to the total weight of a composition.

### Ingredients of the Composition

### Hydrolyzed Compostable Compatibilizer Synthesis

Hydrolyzed compostable compatibilizer production mainly consists of melt-compounding one or more compostable thermoplastic polyesters including but not limited to polylactic acid, polycaprolactone, polybutylene succinate, polybutylene succinate adipate, polybutylene succinate terephthalate, polybutylene adipate-co-terephthalate, and polyhydroxyalkanoates in the presence of one or more organic acids including but not limited to lactic acid, formic acid, stearic acid, tannic acid, malic acid, citric acid, aspartic acid, ascorbic acid, acetic acid, tartaric acid. Typically but not limiting, the polyester(s) is melt-compounded in the presence of 0.01 to 30 weight percent of organic acid(s) using a batch mixer or a recirculating twin screw extruder such as a micro-compounder at elevated temperatures which can be from 50 to 300° C., at a certain mixing screw or mixing blade speed, for example, 20 rpm and above, for a specified time which could be between a few seconds to several minutes. Alternatively, the polyester(s) and organic acid(s) can be melt-compounded using continuous polymer processing methods such as single or twin screw extrusion at elevated temperatures, which can be from 50 to 300° C. and at a certain mixing screw speed, for example, 20 rpm and above, for a specified time which could be between a few seconds to several minutes. Once the desired processing conditions and molecular weight are met, the melt is extruded into strands, cooled, pelletized, and stored away for further use.

### Biodegradable Polyester Elastomer Synthesis

Biodegradable polyester elastomer production mainly consists of the use of a polyol such as pure sorbitol, mannitol, galactitol, xylitol, ribitol, arabitol, erythritol, glycerol, threitol or a derivative thereof and an organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof as the reactants for this invention. The polyols and organic acids can be sourced from fully bio-based, partially bio-based, non-bio-based sources, or a combination thereof. The molar ratio of polyol to dicarboxylic acid could encompass a range from 0.32 to 1.28. Optionally, other additives including but not limited to plasticizer, initiator, filler, compatibilizer, etc. could be added to the synthesis.

These biodegradable polyester elastomers include, but are not limited to, polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd), and poly(maltitol-co-suberate) (PMaS).

The method for the production of the biodegradable polyester elastomer can be any of the following but not limited to these;

In one embodiment, the reactants are mixed together in a reaction vessel and heated to a desired temperature for a certain period of time. In another embodiment, the organic acid is melted prior to the addition of polyol and other optional additives under stirring in a vessel. In another embodiment, the polyol and other optional additives are premixed and heated to a desired temperature before the addition of the organic acid.

In another embodiment, the organic acid and polyol are premixed and heated to a desired temperature prior to the addition of any other optional additives.

In one embodiment, the reaction vessel could be made of heat and crack-resistant glassware, stainless steel, or high-temperature-resistant plastic equipped with an overhead stirrer or another mechanism for the agitation of the reagents. The temperature of the mixture is increased to the desired reaction temperature and maintained throughout the reaction. The reaction is cooled rapidly or slowly to ambient temperature and considered complete after a time period that could range from a few minutes to a few hours.

In one embodiment, the reaction is set at elevated temperatures ranging from 100 to 250° C. Reagents are agitated from the point of mixture and at room temperature. In another embodiment, the agitation is started after the reagents are melted. The reaction is continued until the desired consistency of the elastomer is achieved. In one embodiment, agitation is continued after achieving the desired consistency of elastomer for a time period ranging from a few minutes to a few hours. In another embodiment, the agitation is increased or decreased after achieving the desired consistency of elastomer.

In another embodiment, agitation is stopped after achieving the desired consistency of the elastomer.

### Biodegradable Polymer Resin Composition

The present invention relates to improving the compatibility between biodegradable thermoplastic polyesters with biodegradable polyester elastomers in a biodegradable polymer resin composition through the addition of compatibilizing agents during the melt blending process of the elastomers and the biodegradable thermoplastic polyesters.

The resin composition comprises at least one or more biodegradable thermoplastic polyesters, within a concentration range of 10-99.99 wt. %, one or more biodegradable polyester elastomers within a concentration range of 1-90 wt. %, and one or more compatibilizing agents in a concentration range of 0.01-30 wt. %. In various embodiments, the amount of the one or more biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%. In various embodiments, the amount of the one or more biodegradable polyester elastomers is about 1%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, or about 90%. In various embodiments, the amount of the one or more compatibilizing agents is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

The biodegradable thermoplastic polyesters include but are not limited to, polylactic acid, polycaprolactone, polybutylene succinate, polybutylene succinate adipate, polybutylene succinate terephthalate, polybutylene adipate-co-terephthalate, polyhydroxyalkanoates and a combination thereof.

The biodegradable polyester elastomers include but are not limited to polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd), and poly(maltitol-co-suberate) (PMaS).

The compatibilizing agents include but are not limited to at least one hydrolyzed compostable compatibilizing agent of the current invention or at least one organic acid such as lactic acid, formic acid, stearic acid, tannic acid, malic acid, citric acid, aspartic acid, ascorbic acid, acetic acid, tartaric acid, or a combination thereof.

The type of the hydrolyzed compostable compatibilizing agent depends on the type of resin that will be made in the later biodegradable polymer resin production, but it is not limited to the type of biodegradable thermoplastic polyester(s) with which the elastomer will be blended. Any combination of hydrolyzed biodegradable thermoplastic polyesters, used as compatibilizing agents, can be blended with any combination of biodegradable thermoplastic polyesters and elastomers for resin production.

Additionally, the resin can include plasticizers within a concentration range of 0-30 wt. %, inorganic and organic fillers within a concentration range of 0-30 wt. %, and/or biomass in the concentration range of 0 to about 30 wt. %. In various embodiments, the amount of the amount of the inorganic or organic fillers or the biomass is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

Furthermore, additional additives such as coupling agents, compatibilizers, processing aids, chain extenders, peroxides, initiators, pigments, and cross-linkers may be included with a concentration range of 0 to about 10 wt. %. In various embodiments, the amount of the one or more coupling agents, compatibilizers, processing agents, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

### Biodegradable Polymer Resin Production

The aforementioned ingredients may be processed together in various scenarios. In one scenario, all ingredients are premixed and melt-processed together.

In another embodiment, the biodegradable thermoplastic polyester(s) is melted first, and then the biodegradable elastomer(s) is added to the system before the addition of compostable compatibilizing agent(s) and other additives.

In yet another embodiment, the biodegradable elastomer(s) is first charged into the processing equipment, and then the biodegradable thermoplastic polyester(s) are added to the system before the addition of compostable compatibilizing agent(s) and other additives.

In another embodiment, the biodegradable thermoplastic polyester(s) is melted, followed by the addition of the compostable compatibilizer(s), and then the addition of the biodegradable elastomer(s) along with other additives.

In yet another embodiment, the order of addition is as follows: biodegradable elastomer(s), compostable compatibilizer(s), and biodegradable thermoplastic polyester(s) along with other additives.

The order of introducing the ingredients to the system is not limited to these embodiments and may include any other possible embodiments and combinations.

In one embodiment, the blending of the aforementioned ingredients may be achieved using mixing and melt-compounding equipment with adjustable and controllable temperatures, such as a single or twin screw extruder, or a batch mixer. In a batch mixer, the processing temperature profile may range from 50 to 300° C., and the processing time may be between 5 to 60 minutes.

Alternatively, in embodiments where single or twin screw extrusion is employed, the temperature profile may range from 50 to 300° C., and the screw speed may range from 20 to 250 rpm. It should be noted that the processing conditions provided herein are not limiting and may vary based on other conditions such as ingredient amounts and ratios and the type of processing equipment.

The resulting product may be pelletized and subsequently formed into desired shapes and parts using conventional forming techniques including, but not limited to, injection molding, compression molding, thermoforming, or extrusion. The forming temperature is typically within the range used in the melt-processing and compounding of the resins and ingredients.

### General Embodiment of the Invention

The invention generally encompasses biodegradable compositions of compostable compatibilizers, biodegradable thermoplastic polyesters and biodegradable polyester elastomers and the biodegradable polymer resins made thereof, methods of synthesis and manufacturing, and methods of using the biodegradable resin compositions including, but not limited to (i) about 10-99.99% (w/w) of a polymer comprising one or more of biodegradable thermoplastic polyesters; and (ii) about 1-90% (w/w) of one or more biodegradable polyester elastomers, and (iii) about 0.01-30% (w/w) of one or more compatibilizing agents.

In certain embodiments, the biodegradable compositions could further include one or more additives selected from the group consisting of one or more of (i) a plasticizer in an amount ranging from 0 to 30% (w/w); (ii) an inorganic and/or organic filler in an amount ranging from 0 to 30% (w/w); (iii) a biomass filler in an amount ranging from about 0 to 30% (w/w); (iv) additional additives such as coupling agent(s), compatibilizer(s), pigments, initiator(s), peroxide(s), processing aid(s), chain extender(s), and a cross-linker in an amount ranging from 0 to 10% (w/w), or a combinations thereof.

In certain embodiments, the biodegradable compositions exhibit an improvement in elongation at break of 77% after the compatibilization between the elastomer and the biodegradable thermoplastic polyester using a compatibilizing agent of this invention.

In certain embodiments, the biodegradable compositions exhibit increased rigidity (represented by Young's modulus) by 12% after the compatibilization between the elastomer and the biodegradable thermoplastic polyester using a compatibilizing agent of this invention.

In certain embodiments, the biodegradable compositions exhibit an increase in strength (represented by tensile stress at break) by 18% after the compatibilization between the elastomer and the biodegradable thermoplastic polyester using a compatibilizing agent of this invention.

In certain embodiments, the MFI (melt flow index) decreases by more than 8% after the compatibilization between the elastomer and the biodegradable thermoplastic polyester using a compatibilizing agent of this invention.

In certain embodiments, the processing of the biodegradable compositions to form a finished polymeric product was not possible without the compatibilization of the blend.

In certain embodiments, the processing of the final composition of the biodegradable resin to form a finished polymeric product was realized when a compatibilizing agent of this invention was included in the final composition of the biodegradable resin.

In certain embodiments, the compositions exhibit a bio-based carbon content of up to 100%. In certain embodiment, the composition exhibits a bio-based carbon content of about 10%, 20%, 30%, 40%, 50%, 60%, 70%, 80%, 90%, 95%, or about 100%.

In certain embodiments, the composition exhibits 10%, 20%, 30%, 40%, 50%. 60%, 70%, 80%, or 90% disintegration completion within about 180 to about 365 days at ambient temperature.

In certain embodiments, the composition exhibits 10%, 20%, 30%, 40%, 50%. 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days under thermophilic temperature conditions.

In certain embodiments, the composition exhibits more than 90% biodegradation in less than 90, 100, 110, 120, 130, 140, 150, 160, 170, 175, or 180 days under thermophilic temperature conditions.

In certain embodiments, the biodegradable compositions exhibit 32% disintegration within 45 days under mesophilic (home composting) conditions and 46% disintegration within 45 days under thermophilic (industrial conditions).

In certain embodiments, the composition is 100% compostable.

### Examples

Example 1: Hydrolyzed compatibilizer is produced using a batch mixer or kneader by melt-compounding 2000 grams polylactic acid (PLA) for 5 minutes at 190° C. and then adding 20 grams (i.e. 1 phr or part per hundred resin) of an organic acid. The mixture is allowed to melt-blend for 10 min at 190° C. At this point, the melt is cooled to temperatures of around 100 to 120° C. and extracted. The sample is further cooled to room temperature and then crushed using a crusher, bagged, and stored away for further use.

Example 2: Using organic acid as a compatibilizing agent between a synthesized biodegradable polyester elastomer and a biodegradable thermoplastic polyester blend, produced using a kneader for injection molding applications.

To synthesize the biodegradable elastomer, 691 grams of pure glycerol and 1109 grams of succinic acid, with a molar ratio of 0.8, were mixed within a 3-liter atmospheric pressure reactor at ambient temperature. The synthesis reaction was initiated by elevating the reactor's temperature through a conventional heater equipped with a temperature controller and stirred vigorously with two overhead stirrers. The reaction temperature was set to 180° C. and maintained for approximately 2 hours until gelatinized elastomer was formed. Subsequently, the elastomer was allowed to cool to room temperature before further processing.

To make the final blend, 80 wt. % of PLA was loaded into a preheated kneader operating at 190° C. and 35 rpm and allowed to melt. 1 phr organic acid as the compatibilizer was introduced to the molten PLA and allowed to compound for 2 mins. 20 wt. % of the biodegradable elastomer was then introduced, and blending was continued for an additional 10 minutes under shear and heat. The resulting material was then extracted from the kneader, cooled to room temperature and crushed into small particles using a mechanical crusher. The crushed material was subsequently fed into an injection molding machine with a temperature profile of 160 to 180° C., a screw speed of 75 rpm and a mold at room temperature.

The purpose of injection molding was to make ASTM test bars, enabling the evaluation of the mechanical properties. The results were compared to a blend of 80 wt. % PLA and 20 wt. % of the elastomer without the addition of any compatibilizer. As a result of improved compatibility, the comparative analysis revealed a 5.8% improvement in stress at yield from 37.7 to 39.9 MPa, and elongation at break exhibited a 77.6% improvement from 8.7 to 15.5%. Furthermore, the maximum flexural strength increased by 4.5% from 60.6 to 63.3 MPa.

Example 3: Using a hydrolyzed compostable compatibilizing agent for a blend of a biodegradable polyester elastomer and a biodegradable thermoplastic polyester, produced using a kneader for injection molding applications.

To synthesize the biodegradable elastomer, 691 grams of pure glycerol and 1109 grams of succinic acid, with a molar ratio of 0.8, were mixed within a 3-liter atmospheric pressure reactor at ambient temperature. The synthesis reaction was initiated by elevating the reactor's temperature using a conventional heater equipped with a temperature controller and stirred vigorously with an overhead stirrer. The reaction temperature was set to 180° C. and maintained for approximately 2 hours until gelatinized elastomer was formed. Subsequently, the elastomer was allowed to cool to room temperature before further processing.

To make the final blend, 80 wt. % of PLA was loaded into a preheated kneader operating at 190° C. and 35 rpm and allowed to melt. 20 wt. % of the biodegradable elastomer was introduced to the molten PLA in the kneader. After 5 minutes, 0.3 phr of the hydrolyzed compatibilizing agent from embodiment 1 was added to the kneader and allowed to blend for an additional 5 minutes under shear and in the presence of heat. The resulting material was then extracted from the kneader, cooled to room temperature and crushed into small particles using a mechanical crusher. The crushed material was subsequently fed into an injection molding machine with a temperature profile of 160 to 180° C., a screw speed of 75 rpm and a mold at room temperature.

The purpose of injection molding was to make ASTM test bars, enabling the evaluation of the mechanical properties. The results were compared with a similar blend containing no compatibilizer. As a result of compatibilization, the elongation at break exhibited a 21.3% improvement from 7.5 to 9.1%. Furthermore, the maximum flexural strength increased by 14.8% from 45.2 to 51.9 MPa. The Izod impact strength increased by 28.2% from 22.9 to 29.3 J/m, while the melt flow index (MFI) decreased by 8.9% from 63.1 to 57.5 g/10 min.

Example 4: Using a hydrolyzed compostable compatibilizing agent for a blend of synthesized biodegradable polyester elastomer and a biodegradable thermoplastic polyester produced using a kneader for cast extrusion film applications.

To synthesize the biodegradable elastomer, 691 grams of pure glycerol and 1109 grams of succinic acid, with a molar ratio of 0.8, were mixed within a 3-liter atmospheric pressure reactor at ambient temperature. The synthesis reaction was initiated by elevating the reactor's temperature using a conventional heater equipped with a temperature controller and stirred vigorously with an overhead stirrer. The reaction temperature was set to 180° C. and the reaction proceeded for approximately 2 hours until gelatinized elastomer was formed. Subsequently, the elastomer was allowed to cool to room temperature before further processing.

To make the final blend, 80 wt. % of PLA was loaded into a preheated kneader operating at 190° C. and 35 rpm and allowed to melt. 20 wt. % of the biodegradable elastomer was introduced to the molten PLA in the kneader along with 0.3 phr of the hydrolyzed compatibilizing agent from embodiment 1 and allowed to blend for an additional 10 minutes under shear and the presence of heat. The resulting material was then extracted from the kneader, cooled to room temperature, and crushed into small particles using a mechanical crusher.

The crushed material was then fed into a cast film extruder with a temperature profile of 140 to 170° C. and screw speed of 50 rpm, to form a film with a thickness of 0.32 mm and a width of 10-12 inches. The film was cooled and pulled over a set of chiller rollers and wound into a roll using a spool. The properties of film and resin were then tested using ASTM methods.

The results from the test were compared with a film produced without any compatibilizing agent. As a result of the compatibilization, the stress at yield was improved by 13.7 and 15.6% from 31.5 to 35.8 MPa and from 25.4 to 29.4 MPa for films in machine and transverse directions, respectively. The stress at break was improved by 16.3 and 18.4% from 27 to 31.4 MPa and from 25.4 to 29.4 MPa for films in machine and transverse directions, respectively. Young's modulus improved by 7.8 and 12.4%, from 1769 to 1907 MPa and 1621 to 1822 MPa for the films in machine and transverse directions, respectively.

Example 5: Using an organic acid as a compatibilizing agent for a blend of a biodegradable polyester elastomer and a biodegradable thermoplastic polyester produced using a kneader for film applications.

850 grams of pure glycerol and 1700 grams of succinic acid, with a molar ratio of 0.64, were premixed in a 3-liter atmospheric pressure reactor at ambient temperature. The reaction was initiated by elevating the reactor's temperature using a conventional heater, equipped with a temperature controller and stirred vigorously with one overhead stirrer. The reaction temperature was set to 180° C. and allowed to react for approximately 3 hours until gelatinization was achieved. Subsequently, the elastomer was allowed to cool to room temperature before further processing.

50 wt. % PBAT was charged into the kneader and melted at 160° C. 50 wt. % of the elastomer was then added to the molten PBAT. After 10 minutes, 0.1 phr of organic acid as the compatibilizing agent was added to the system. Mixing was continued under shear and heat until a uniform blend was achieved visually.

The resulting blend was then extracted from the kneader, cooled to room temperature and crushed into small particles using a mechanical crusher. The crushed blend was then extruded into a film roll with a thickness of 0.36 mm and a width of 10-12 inches, using a cast film extruder with a temperature profile of 135 to 145° C. and a screw speed of 100 rpm. The film was cooled and pulled using a set of chiller rollers and wound into a spool of film using a winding roller.

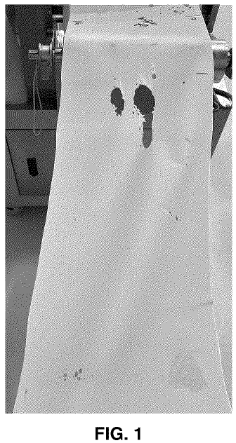

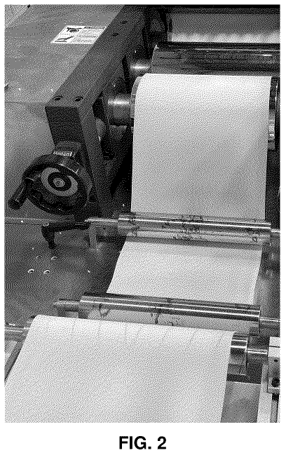

Films produced with and without any compatibilizing agent were compared during the cast film extrusion process.t. It was observed that the blend without any compatibilizing agent was not compatible with the cast film extrusion process as a result of ingredients incompatibility and poor melt strength. This caused rips, tears and holes in the films (FIG. 1). However, the compatibilized blend was extruded into a continuous film with no rips, tears, or holes (FIG. 2).

Example 6: Using organic acid as a compatibilizing agent for a blend of a biodegradable polyester elastomer and a biodegradable thermoplastic polyester produced using a kneader for film applications.

495 grams of pure glycerol and 705 grams of succinic acid, with a molar ratio of 0.9, were mixed in a 3-liter atmospheric pressure reactor at ambient temperature. The synthesis was initiated by elevating the temperature of the reactor using a conventional heater, equipped with a temperature controller while stirring vigorously with an overhead stirrer. The reaction temperature was set to 180° C. and allowed to proceed for approximately 2 hours until gelatinized elastomer was formed. Subsequently, the elastomer was allowed to cool to room temperature before further processing.

47.3 wt. % of PLA was charged into the kneader and allowed to melt at 180° C. 13 wt. % of isosorbide diester was added as a plasticizer thereafter. Subsequently, 39.6 wt. % of the synthesized biodegradable elastomer was added, and the blending continued for another 17 minutes. This was followed by the addition of 0.1 wt. % organic acid as a compatibilizer. The blending was allowed to continue for an additional 7 minutes, in the presence of heat and shear. The blend was extracted from the kneader, cooled to room temperature, and subjected to crushing, converting it into small particles using a mechanical crusher.

The crushed particles were then fed into and melted in a cast film extruder with a temperature profile of 140 to 160° C. and screw speed of 80 rpm to form a film with a thickness of 0.46 mm and a width of 10-12 inches. The produced film was chilled down and pulled via a set of chiller rollers and guiding and winding rollers to form a wound spool of the film.

The disintegration properties of this composition were then tested under ASTM D6400 standards. The results showed 32% disintegration within 45 days under mesophilic conditions and 46% disintegration within 45 days under thermophilic conditions.

In other embodiments, the invention includes methods for preparing the compostable hydrolyzed compatibilizer. The method for the production of the hydrolyzed compatibilizer can be any of but not limited to the following combinations.
(i) In one embodiment, the hydrolyzed compatibilizer is produced by melt-compounding one biodegradable thermoplastic polyester with one organic acid.
(ii) In one embodiment, the hydrolyzed compatibilizer is produced by melt-compounding one or more biodegradable thermoplastic polyesters with one organic acid.
(iii) In one embodiment, the hydrolyzed compatibilizer is produced by melt-compounding one or more biodegradable thermoplastic polyesters with one or more organic acids.
(iv) In one embodiment, the hydrolyzed compatibilizer is produced by melt-compounding one biodegradable thermoplastic polyester with one or more organic acids.
(v) In one embodiment, the hydrolyzed compatibilizer is produced by first melting one or more biodegradable thermoplastic polyesters and then compounding with one or more organic acids.
(vi) In one embodiment, the hydrolyzed compatibilizer is produced by melt-compounding one or more biodegradable thermoplastic polyesters with one or more organic acids and then further melt-compounding with one or more biodegradable thermoplastic polyesters and organic acids.
(vii) In one embodiment, the hydrolyzed compatibilizer is produced by melt-compounding one or more biodegradable thermoplastic polyesters with one or more organic acids and then further compounding with one or more biodegradable thermoplastic polyesters.

In one embodiment, the aforementioned ingredients and method of production may be achieved using mixing and melt-compounding equipment with adjustable and controllable temperatures, such as a single or twin screw extruder, or a batch mixer.

In one embodiment, in a batch mixer, the processing temperature profile may range from 50 to 300° C., the mixing blade speed may be between 20 and 500 rpm and the processing time may be between a few seconds to several minutes.

Alternatively, in embodiments where single or twin screw extrusion is employed, the temperature profile may range from 50 to 300° C., and the screw speed may range from 20 to 250 rpm.

It should be noted that the processing conditions and methods of production provided herein are not limiting and may vary based on other conditions such as ingredient amounts and ratios and the type of processing equipment.

The order of mixing the raw ingredients is not limited only to the above-mentioned embodiments may include any other possible combinations.

In certain embodiments, the hydrolyzed compatibilizing agent includes but is not limited to hydrolyzed polylactic acid, hydrolyzed polycaprolactone, hydrolyzed polybutylene succinate, hydrolyzed polybutylene succinate adipate, hydrolyzed polybutylene succinate terephthalate, hydrolyzed polybutylene adipate terephthalate, hydrolyzed polyhydroxyalkanoates, or a combination thereof, where the hydrolyzation is achieved by melt-compounding over a specified time and temperature.

In certain embodiments, the compostable polyester for production of the hydrolyzed compatibilizing agent includes but is not limited to polylactic acid, polycaprolactone, polybutylene succinate, polybutylene succinate adipate, polybutylene succinate terephthalate, polybutylene adipate terephthalate, polyhydroxyalkanoates, or a combination thereof, where the hydrolyzation is achieved by melt-compounding over a specified time and temperature.

In certain embodiment, the organic acid(s) for the production of compostable compatibilizing agents includes but are not limited to at least one organic acid such as lactic acid, formic acid, stearic acid, tannic acid, malic acid, citric acid, aspartic acid, ascorbic acid, acetic acid, tartaric acid, compostable hydrolyzed compatibilizer of the current invention or a combination thereof.

In certain embodiments, the compositions include one or more polymers. In these embodiments, one or more of these polymers are biodegradable thermoplastic polyesters including, but not limited to, polylactic acid, polycaprolactone, polybutylene succinate, polybutylene succinate adipate, polybutylene succinate terephthalate, polybutylene adipate terephthalate, polyhydroxyalkanoates.

In certain embodiments, the compositions include one or more biodegradable polyester elastomers.

In certain embodiments, the biodegradable polyester elastomer is inclusive of but not limited to polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd) and poly(maltitol-co-suberate) (PMaS).

In certain embodiments, the composition includes biomass, inorganic filler, coupling agent, plasticizer, and other additives.

In certain embodiments, the biomass includes but is not limited to, distillers' grains, vinasse, vinegar residues, wood fiber, virgin starch, modified starch including thermoplastic starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the inorganic filler includes but is not limited to, wollastonite, mica, clay, calcium carbonate, glass fiber, talc, aluminum silicate, zirconium oxide, gypsum and other minerals and a combination thereof.

In certain embodiments, the plasticizers encompass, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin form or post-modification (e.g., through epoxidation, carboxylation, hydroxylation, and amidation). Modified plant-based oils such as epoxidized soybean oil, epoxidized linseed oil, fatty acid methyl esters, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In certain embodiments, the coupling agent or compatibilizer includes but is not limited to the hydrolyzed compatibilizer of this invention, titanate, aluminate, peroxides, γ-aminopropyltriethoxysilane, γ-(2,3) epoxy (propoxy) propyltrimethoxy-silane, γ-methacryloxypropyltrimethoxysilane, lactic acid, formic acid, stearic acid, tannic acid, malic acid, citric acid, aspartic acid, ascorbic acid, acetic acid, tartaric acid.

In other embodiments, the invention includes methods for preparing the biodegradable composition comprising the following steps; preparing the hydrolyzed compostable compatibilizing agent then melt blending uniformly and thoroughly with one or more biodegradable thermoplastic polyesters, synthesized biodegradable polyester elastomers and other raw materials of the biodegradable composition at higher than ambient temperatures to prepare the biodegradable composition.

In other embodiments, the invention includes methods for preparing the biodegradable composition comprising the following steps; uniformly and thoroughly melt blending one or more organic acids as compatibilizing agent with one or more biodegradable thermoplastic polyesters, synthesized biodegradable polyester elastomers and other raw materials of the biodegradable composition at higher than ambient temperatures to prepare the biodegradable composition.

In other embodiments, the invention includes methods for preparing the biodegradable composition comprising the following steps; preparing the hydrolyzed compostable compatibilizing agent then melt blending it uniformly and thoroughly with one or more biodegradable thermoplastic polyesters, synthesized biodegradable elastomers, organic acid compatibilizers and other raw materials of the biodegradable composition at higher than ambient temperatures to prepare the biodegradable composition.

In certain embodiments, the method further comprises forming the produced biodegradable composition resin into finished polymeric parts using conventional polymer processing techniques comprising thermoforming, hot press, vacuum forming, cast extrusion, film blowing, injection molding, or compression molding.

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A hydrolyzed compostable compatibilizer comprising:
a. about 70 to about 99.99% (w/w) of at least one biodegradable thermoplastic polyester selected from the group consisting of polylactic acid, polycaprolactone, polybutylene succinate, polybutylene succinate adipate, polybutylene succinate terephthalate, polybutylene adipate-co-terephthalate, polyhydroxyalkanoates and a combination thereof, and
b. about 0.01 to about 30% (w/w) of an organic acid selected from the group consisting of lactic acid, formic acid, stearic acid, tannic acid, malic acid, citric acid, aspartic acid, ascorbic acid, acetic acid, tartaric acid or a combination thereof.

2. A biodegradable resin composition comprising:
a. about 10 to about 99% (w/w) of a polymer comprising one or more biodegradable thermoplastic polymers;
b. about 1 to about 90% (w/w) of biodegradable polyester elastomers;
c. about 0.01 to about 30% (w/w) of at least one compatibilizing agent selected from the group of hydrolyzed compostable compatibilizer or at least one organic acid or a combination thereof, wherein the organic acid is selected from the group consisting of lactic acid, formic acid, stearic acid, tannic acid, malic acid, citric acid, aspartic acid, ascorbic acid, acetic acid, tartaric acid, or a combination thereof;
d. about 0 to about 30% (w/w) of one or more plasticizers;
e. about 0 to about 30% (w/w) of one or more inorganic fillers;
f. about 0 to about 30% of fiber comprising one or more of biomass; and
g. about 0 to about 10% (w/w) of one or more of additives selected from the groups consisting of coupling agents, compatibilizers, processing aids, chain extenders, peroxides, initiators, pigments, and cross-linkers or a combination thereof.

3. The biodegradable resin composition of claim 2, wherein the biodegradable thermoplastic polymer comprises one or more biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates, and a combination thereof.

4. The biodegradable resin composition of claim 2, wherein the biodegradable polyester elastomer is a synthesized product of at least one polyol selected from the group consisting of sorbitol, mannitol, galactitol, xylitol, ribitol, arabitol, erythritol, glycerol, threitol and a derivative thereof, and at least one organic acid selected from the group consisting of succinic acid, sebacic acid, glutaric acid, hexanedioic acid, heptanoic acid, octanedioic acid, nonanedioic acid, and decanoic acid or a derivative thereof, wherein the molar ratio of the polyol to the organic acid is about 0.32 to 1.28.

5. The biodegradable resin composition of claim 2, wherein the plasticizer is a plant-based oil selected from the group consisting of vegetables, nuts, grains, seeds, or combinations thereof wherein the oils comprise corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

6. The biodegradable resin composition of claim 2, wherein the inorganic filler is selected from the group consisting of wollastonite, mica, clay, calcium carbonate, glass fiber, talc, aluminum silicate, zirconium oxide, sepiolite, gypsum and a combination thereof.

7. The biodegradable resin composition of claim 2, wherein the biomass is selected from distillers' grains, vinasse, vinegar residues, wood fiber, virgin starch, modified starch (including thermoplastic starch), agricultural cellulosic matter, straw, stalk, shive, hurd, bast, leaf, seed, fruit, and perennial grass, all in a non-continuous non-woven form, which may consist of chopped pieces, particulates, dust, or flour.

8. The biodegradable resin composition of claim 2, further comprising a resin of at least one biodegradable polyester elastomer, one biodegradable thermoplastic polyester, and one compostable compatibilizing agent, wherein the composition exhibits enhanced compatibility as evidenced by improved mechanical properties compared to a similar composition made without any compostable compatibilizing agent.

9. The biodegradable resin composition of claim 2, wherein the bio-based carbon content of the composition is up to 100%.

10. The composition of hydrolyzed compostable compatibilizer of claim 1, wherein the bio-based carbon content of the compatibilizer is up to 100%.

11. The biodegradable resin composition of claim 2, wherein the bio-based carbon content of the biodegradable elastomer is up to 100%.

12. The composition of claim 2, wherein the composition exhibits 32% disintegration within 45 days under mesophilic conditions and 46% disintegration within 45 days under thermophilic conditions.

13. The composition of hydrolyzed compostable compatibilizer of claim 1, wherein the composition exhibits more than 90% disintegration in less than 84 days and more than 90% biodegradation in less than 180 days under thermophilic temperature conditions.

14. The biodegradable resin composition of claim 2, wherein the composition exhibits more than 90% disintegration in less than 84 days and more than 90% biodegradation in less than 180 days and under thermophilic temperature conditions.

15. A method of producing the hydrolyzed compostable compatibilizer of claim 1 in which one or more biodegradable thermoplastic polyesters and one or more organic acids are mixed and melt-compounded together in a polymer processing equipment or apparatus selected from a batch mixer, a twin screw extruder and a single screw extruder, at an elevated temperature above the melting point of the biodegradable thermoplastic polyesters for a time period of several seconds to several minutes.

16. A method of producing the biodegradable resin composition of claim 2 in which the ingredients are mixed and melt-compounded together in a polymer processing equipment or apparatus selected from a batch mixer, a twin screw extruder and a single screw extruder, at a temperature ranging from 50° C. to 250° C. for a time period of several seconds to several minutes,

17. The biodegradable resin composition of claim 2 wherein the biodegradable polyester elastomer is produced by reacting the ingredients at a temperature ranging from 100 to 250° C., continuing the reaction until completion.

18. The biodegradable resin composition of claim 2 for use to make articles using conventional polymer processing techniques selected from cast film extrusion and injection molding techniques.
